(19) United States
(12) Patent Application Publication
(10) Pub. No.: US 2026/0319975 A1
(43) Pub. Date: Oct. 15, 2026

(54) SECURE USER-CUSTOMIZABLE PERIPHERAL DEVICE

(71) Applicant: Overlord Labs, Inc., San Jose, CA (US)

(72) Inventors: Joseph CROP, Lake Oswego, OR (US); David MAXWELL, San Jose, CA (US); Carlos RODRIGUEZ, Gilroy, CA (US); Rafael MEDINA, San Jose, CA (US); Richard NICHOLSON, Aptos, CA (US)

(73) Assignee: Overlord Labs, Inc., San Jose, CA (US)

(21) Appl. No.: 19/648,924

(22) Filed: Apr. 15, 2026

Related U.S. Application Data
(60) Provisional application No. 63/789,230, filed on Apr. 15, 2025.

(51) Int. Cl. G06F 13/10

(52) U.S. Cl. CPC G06F 13/10; G06F 2213/40

(57) ABSTRACT

A management system for an electronic device may include an algorithm processor core, a customer micro-processor, and a hardware-implemented access orchestrator disposed on a unitary integrated circuit. The algorithm processor core may execute protected firmware that is inaccessible to an end-user, and may have unrestricted access to one or more hardware resources of the electronic device. The customer micro-processor may execute end-user firmware that is independently programmable by the end-user. The access orchestrator may intercept requests from the customer micro-processor to access the one or more hardware resources and may selectively permit or deny the requests based on permissions established by the algorithm processor core. The customer micro-processor may be presented to the end-user as the sole processor of the management system such that the algorithm processor core is transparent to the end-user.

### CROSS-REFERENCES TO OTHER APPLICATIONS

This application claims priority to U.S. provisional patent application Ser. No. 63/789,230, for “SECURE USER-CUSTOMIZABLE PERIPHERAL DEVICE” filed on Apr. 15, 2025, which is hereby incorporated by reference in entirety for all purposes.

### FIELD

The disclosure relates to integrated circuit devices. More particularly, the disclosure relates to focused-purpose integrated peripheral devices comprising multiple processor cores with hardware-enforced access control between the cores.

### BACKGROUND

Battery management systems (BMS) play a critical role in modern battery-powered devices. These systems typically consist of a combination of analog and digital circuits, along with a customer-provided microcontroller. The primary functions of a BMS include ensuring safety and, in many cases, providing additional features such as state-of-charge (SOC) and state-of-health (SOH) estimations. These features help predict the future state of the battery, offering valuable insights to the host system, such as the time remaining until the battery is empty or fully charged. These advanced functionalities are often implemented as proprietary algorithms tailored to specific battery chemistries. These algorithms are typically embedded in the BMS integrated circuit (IC) by the IC manufacturer. However, many customers require the ability to customize the BMS functionality, including these algorithms, to meet their specific needs.

New electronic devices require new features or new methods of implementing customized BMS functionality and/or algorithms to improve performance and/or features.

### SUMMARY

In some embodiments, a management system for an electronic device comprises an algorithm processor core configured to execute protected firmware that is inaccessible to an end-user, wherein the firmware controls at least one parameter of the electronic device and wherein the algorithm processor core has unrestricted access to one or more hardware resources of the electronic device, an assistant processor core accessible to the end-user and configured to execute end-user firmware independently programmable by the end-user, and a hardware-implemented access orchestrator configured to intercept requests from the assistant processor core to access the one or more hardware resources of the electronic device and to selectively permit or deny the requests based on permissions established by the algorithm processor core, wherein the algorithm processor core, the assistant processor core and the access orchestrator are disposed on a unitary integrated circuit. In various embodiments, the protected firmware is not accessible via a programming interface of the assistant processor core. In some embodiments, the at least one parameter of the electronic device includes a state of charge.

In various embodiments, the one or more hardware resources of the electronic device include a memory. In some embodiments, the electronic device is a rechargeable battery and the management system is a battery management system for the rechargeable battery. In various embodiments, the one or more hardware resources comprise a shadow memory accessible by the assistant processor core, and the shadow memory corresponds to a portion of a physical memory shared with the algorithm processor core. In some embodiments, the assistant processor core's access to the shadow memory is controlled by the algorithm processor core. In various embodiments, the electronic device is a security authentication token. In some embodiments, the electronic device further comprises one or more hardware-implemented peripheral interfaces including a pulse-width modulated unit, an I2C serial bus, a real-time clock, a timer, or a watchdog timer. In various embodiments, the access orchestrator exchanges information between the algorithm processor core and the assistant processor core using message passing in a shared memory. In some embodiments, the access orchestrator exchanges information between the algorithm processor core and the assistant processor core using data packets.

In various embodiments, a method of operating a management system for an electronic device comprises executing, on an algorithm processor core of a unitary integrated circuit, protected firmware that is inaccessible to an end-user, executing, on an assistant processor core of the unitary integrated circuit, end-user firmware that is independently programmable by the end-user, intercepting, by a hardware-implemented access orchestrator of the unitary integrated circuit, requests from the assistant processor core to access one or more hardware resources of the electronic device, and selectively permitting or denying the intercepted requests based on permissions established by the algorithm processor core. In some embodiments, the method further comprises presenting the assistant processor core to the end-user as a sole processor of the management system, such that the algorithm processor core is inaccessible to the end-user. In various embodiments, the method further comprises configuring, by the algorithm processor core, a programmable partition of a shared physical memory to define a shadow memory region accessible by the assistant processor core. In some embodiments, the method further comprises controlling the assistant processor core's access to the shadow memory with the algorithm processor core. In various embodiments, the access orchestrator exchanges information between the algorithm processor core and the assistant processor core using message passing in a shared memory.

In some embodiments, a unitary integrated circuit comprises an algorithm processor core configured to execute protected firmware that is inaccessible to an end-user of the integrated circuit, wherein the firmware controls at least one parameter of an electronic device and wherein the algorithm processor core has unrestricted access to one or more hardware resources of the electronic device, an assistant processor core configured to execute end-user firmware independently programmable by the end-user, and an access orchestrator coupled between the algorithm processor core and the assistant processor core and configured to intercept requests from the assistant processor core to access the one or more hardware resources of the electronic device and to selectively permit or deny the requests based on permissions established by the algorithm processor core. In various embodiments, the assistant processor core is presented to the end-user as a sole processor of the unitary integrated circuit.

In some embodiments, the access orchestrator is further configured to enforce a programmable partition of a shared physical memory, the programmable partition defining a shadow memory region accessible by the assistant processor core and controlled by the algorithm processor core. In various embodiments, the access orchestrator exchanges information between the algorithm processor core and the assistant processor core using message passing in a shared memory. In some embodiments, a management system for an electronic device comprises an algorithm processor core configured to execute protected firmware that is inaccessible to an end-user, wherein the firmware controls at least one parameter of the electronic device and wherein the algorithm processor core has unrestricted access to one or more hardware resources of the electronic device, an assistant processor core accessible to the end-user and configured to execute end-user firmware independently programmable by the end-user, and a hardware-implemented access orchestrator configured to intercept requests from the assistant processor core to access the one or more hardware resources of the electronic device and to selectively permit or deny the requests based on permissions established by the algorithm processor core, wherein the algorithm processor core, the assistant processor core and the access orchestrator are disposed on a unitary integrated circuit.

### BRIEF DESCRIPTION OF THE DRAWINGS

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

The disclosure may be better understood with reference to the following drawings, in which like reference numerals designate like components throughout the views.

FIG. 1 illustrates a block diagram of a battery management system employing an external customer microcontroller connected to a battery management integrated circuit.

FIG. 2 illustrates a block diagram of a battery management system employing a focused-purpose integrated peripheral device having an isolated algorithm processor system and a customer-programmable microprocessor on a single integrated circuit, in accordance with embodiments of the disclosure.

FIG. 3 illustrates a simplified schematic of a system architecture of a focused-purpose integrated peripheral device comprising an algorithm core, a customer micro-processor, and an access orchestrator, in accordance with embodiments of the disclosure.

FIG. 4 illustrates a simplified block diagram of a configurable algorithm gateway showing parameter types exposed between an algorithm and a customer interface, in accordance with embodiments of the disclosure.

FIG. 5 illustrates a simplified block diagram of a configurable algorithm gateway showing customer-defined function override and optional output validation, in accordance with embodiments of the disclosure.

FIG. 6 illustrates a simplified block diagram of a hidden memory coordinator showing programmable read and write partitions shared between an algorithm core and a customer micro-processor, in accordance with embodiments of the disclosure.

FIG. 7 illustrates a simplified block diagram of a hidden peripheral coordinator showing access control and resource sharing between an algorithm core and a customer micro-processor for a general hardware peripheral, in accordance with embodiments of the disclosure.

FIG. 8 illustrates a simplified block diagram of a hidden peripheral coordinator configured for a serial interface peripheral, showing dedicated memory spaces and address-based routing between an algorithm core and a customer micro-processor, in accordance with embodiments of the disclosure.

FIG. 9 illustrates a simplified block diagram of a dual redundant supervisor showing watchdog timer elements connecting an algorithm core and an customer micro-processor, in accordance with embodiments of the disclosure.

According to common practice, the various features of the drawings discussed below are not necessarily drawn to scale. Dimensions of various features and elements in the drawings may be expanded or reduced to more clearly illustrate the embodiments of the disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques disclosed herein relate generally to focused-purpose integrated peripheral devices (FPIPDs). More specifically, techniques disclosed herein relate to FPIPDs comprising an algorithm core and a customer-programmable customer micro-processor coupled through a hardware-implemented access orchestrator. The algorithm core may retain supervisory control over the customer micro-processor's access to memory, interfaces, and algorithms of the peripheral device, while the customer micro-processor may simultaneously be exposed to an end-user for independent programming, thereby enabling enhanced customization of device functionality without compromising the integrity, safety, or intellectual property of the core device algorithms. Various embodiments are described herein, including methods, processes, systems, devices, and the like.

In order to better appreciate the features and aspects of the present disclosure, further context for the disclosure is provided in the following section by discussing one particular implementation of a FPIPD for a battery management system that includes an algorithm core, an customer micro-processor, and an access orchestrator according to embodiments of the disclosure. These embodiments are for explanatory purposes only and other embodiments may be employed in other electronic systems. For example, embodiments of the disclosure can be used with any device that requires secure, partitioned firmware execution environments in which a customer-programmable processing core operates alongside a protected algorithm core, such as battery management systems, security authentication tokens, industrial controllers, or embedded sensing platforms. In some instances, embodiments of the disclosure are particularly well suited for use with battery management integrated circuits because of the need to maintain algorithmic integrity while simultaneously providing a flexible, customer-accessible programming interface within the same device.

The present invention relates to a FPIPD that incorporates two distinct processing cores within a single integrated circuit: a protected algorithm core that executes the device's primary, proprietary functions, and a customer-programmable customer micro-processor that end-users can freely program to customize device behavior. A hardware-implemented access orchestrator sits between these two cores and acts as a gatekeeper, ensuring that the customer-programmable core can only access the device's memory, peripherals, and internal algorithms to the extent that the protected algorithm core permits. In this way, the device manufacturer's proprietary firmware and safety-critical operations remain protected, while the end-user simultaneously enjoys a rich, flexible programming environment that appears, from the outside, as though it were the sole processor on the device.

A particularly well-suited application of this invention is in battery management integrated circuits, where it is essential to maintain the integrity of core battery protection and monitoring algorithms while also giving battery pack designers the freedom to implement custom charging profiles, communication protocols, and application-specific logic. The system achieves this by providing shadow memory and shadow peripheral resources that the customer micro-processor interacts with, while the hidden algorithm core retains ultimate supervisory control over what data is read, what data is written, and which peripheral functions are exercised. A dual-redundant watchdog supervisor further ensures that neither core can compromise the safe operation of the overall system, providing an additional layer of reliability that may be beneficial in safety-sensitive applications.

Using an external customer microcontroller to configure the BMS may increase cost, space requirements, system complexity, power consumption, and development effort. Requesting the IC supplier to implement features in custom firmware may be expensive and may not always be feasible due to system limitations, and may raise concerns about intellectual property protection. Such requests may also increase the risk of introducing new bugs and may complicate liability issues, particularly where changes interfere with safety functions. Purchasing a BMS IC with a safety or algorithm code library designed to run on the IC may allow direct modification of the code but may make it challenging to protect the software's intellectual property, and may require development effort to ensure existing algorithms are not inadvertently affected. Purchasing a BMS IC with no built-in safety or BMS functions may require customers to develop all BMS firmware, including complex algorithms, from scratch, and may demand extensive development effort while risking oversight of safety corner cases that IC vendors have refined over years of experience.

Battery management systems (BMS) are used in modern battery-powered devices. These systems may consist of a combination of analog and digital circuits, along with a customer-provided microcontroller. The primary functions of a BMS may include ensuring safety and, in many cases, providing additional features such as state-of-charge (SOC) and state-of-health (SOH) estimations. These features may help predict the future state of the battery, offering information to the host system, such as the time remaining until the battery is empty or fully charged. These advanced functionalities may be implemented as proprietary algorithms tailored to specific battery chemistries. These algorithms may be embedded in the BMS integrated circuit (IC) by the IC manufacturer. However, many customers may require the ability to customize the BMS functionality, including these algorithms, to meet their specific needs.

Some embodiments of this disclosure may enable customizations to enhance the functionality of a user's BMS. Examples of such customizations include controlling LEDs or displays, developing custom charging algorithms that optimize charge current and voltage based on real-time readings, and modifying the battery level percentage displayed to the user. Other customizations may involve collecting and reporting proprietary telemetry data, utilizing low-level BMS measurements to replace or augment the IC manufacturer's algorithms, and implementing custom authentication mechanisms to validate the originality of the battery pack. Additionally, customers may encrypt communication data to protect intellectual property, update standardized battery state registers such as those defined by the Smart-Battery-System (SBS) specification, and log usage statistics in non-volatile memory.

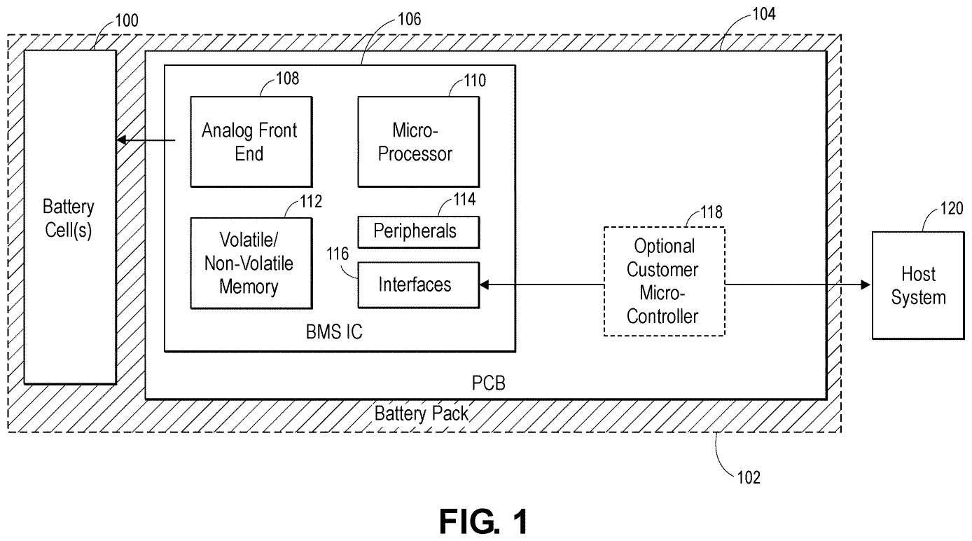

FIG. 1 illustrates an example system for implementing one or more of the aforementioned customizations, but this example system may have one or more drawbacks, some of which are enumerated below. The system includes battery cells 100 within a battery pack 102, with a PCB 104 containing a BMS IC 106. The BMS IC 106 includes an analog front end 108, micro-processor 110, volatile/non-volatile memory 112, peripherals 114, and interfaces 116. An optional customer micro-controller 118 may be connected between the BMS IC 106 and host system 120.
a) Using an external customer microcontroller to configure the BMS:
   i. Increases cost, space requirements, system complexity, power consumption, and development effort.
b) Requesting the IC supplier to implement features in custom firmware:
   ii. Expensive and may not always be feasible due to system limitations.
   iii. Raises concerns about intellectual property protection.
   iv. Increases the risk of introducing new bugs, complicating liability issues, especially if changes interfere with critical safety functions.
c) Purchasing a BMS IC with a safety/algorithm code library designed to run on the IC:
   v. Allows direct modification of the code but makes it challenging to protect the software's intellectual property.
   vi. Requires significant development effort to ensure existing algorithms are not inadvertently broken.
d) Purchasing a BMS IC with no built-in safety or BMS functions:
   vii. Requires customers to develop all the BMS firmware, including complex algorithms, from scratch.
   viii. Demands extensive development effort and risks overlooking critical safety corner cases that IC vendors have refined over years of experience.

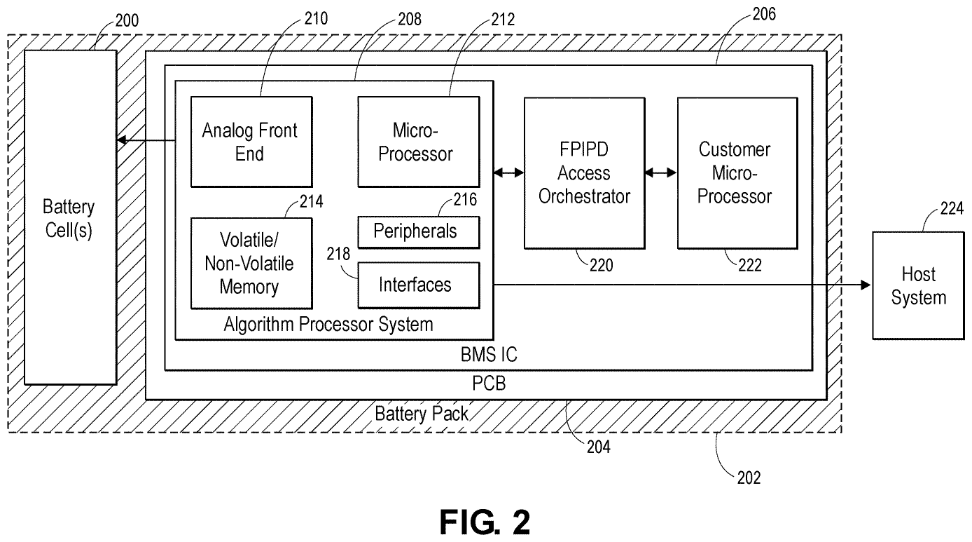

FIG. 2 illustrates an example system for implementing one or more of the aforementioned customizations and may not have one or more of the aforementioned drawbacks. As shown in FIG. 2, the example system employs a single BMS IC 206 with an isolated algorithm processor system 208 and customer micro-processor (also referred to as an assistant processor core herein) 222. The system includes battery cells 200 within a battery pack 202, with a PCB 204 containing the BMS IC 206. The algorithm processor system 208 includes an analog front end 210, micro-processor 212, volatile/non-volatile memory 214, peripherals 216, and interfaces 218. The BMS IC 206 also includes a focused-purpose integrated peripheral device (“FPIPD”) access orchestrator 220 and customer micro-processor 222, which connects to host system 224. The algorithm processor 208 runs the safety and algorithm software developed by the IC manufacturer, such that it remains uninterrupted by any customer code running on the customer processor 222. The algorithm processor 208 retains full control of the hardware peripherals 216, and the customer processor 222 requests access to these peripherals, which is granted when deemed safe by the algorithm processor 208. From the customer processor's 222 perspective, the algorithm processor 208 functions as a specialized peripheral, enabling enhanced customization without compromising core functionality or safety.

This architecture may offer several benefits. IP segregation may ensure the IC manufacturer and customer do not share code or access each other's intellectual property, preventing theft and reverse engineering. Safety may be improved by ensuring customer software cannot interfere with the operation of safety and algorithm functions. Customers may be able to override and control certain non-critical BMS functions through their code. The architecture may eliminate the need for customers to rely on the IC manufacturer for code iterations, thereby reducing development time. Part count and associated costs may be reduced by eliminating the need for an external microcontroller. The quality and reliability of the IC vendor's expertise and intellectual property may be retained. Clear boundaries for ownership of code and system functions may be established. The customer processor may also validate the algorithm processor's operation and confirm that it generates valid results.

The BMS IC architecture illustrated in FIG. 2 provides a robust solution that balances safety, customization, and efficiency, addressing the limitations of current approaches while offering significant advantages to both IC manufacturers and customers.

As shown in FIG. 2, in some embodiments FPIPDs (e.g., FPIPD Access Orchestrator 220), such as battery management supervisors and security authentication tokens perform complicated and intensive computations to meet performance expectations. FPIPDs may employ purpose-designed analog, digital and/or mixed-mode circuitry to enable the FPIPD to achieve high-speed and high-reliability operation at low power levels. In some embodiments at least part of the focused-purpose functionality may be implemented by the FPIPD designer in proprietary and confidential firmware executing on an embedded microcontroller core whose presence is largely hidden from the third-party design engineers who purchase the FPIPD for integration into end systems (“the end-user”).

In some embodiments one or more user-programmable customer micro-processors may be coupled to the FPIPD architecture, coupled to the main core (or multiple main cores) by the FPIPD Access Orchestrator 220.

The algorithm core 208 (the firmware for which may remain under the secure control of the FPIPD designer) may operate independently of the customer micro-processor 222, maintaining supervisory control of the FPIPD 220 at all times, and controlling the customer micro-processor's ability to access memory, interfaces, and algorithms of the FPIPD. This may ensure that operations, algorithms, and timing of the FPIPD are protected from interference by any end-user code executing on the customer micro-processor.

The customer micro-processor 222 (also referred to herein as the “assistant core” or “assistant processor core”) may simultaneously be exposed to the end-user and programmed independently, as if it were an on-chip version of the external microcontroller, so as to appear to the end-user as if it is the master controller of the FPIPD 220. However, because the customer micro-processor's 222 access to memory, interfaces, algorithms, and the like may at all times be supervised and controlled under the direction of the algorithm core 208, the FPIPD designer may ensure the integrity of the overall FPIPD at all times, and therefore maintain the verification of core FPIPD operation.

As used herein, the customer micro-processor 222 is described as “accessible to the end-user” to mean that the customer micro-processor exposes a programming interface, debug interface, and/or memory space that the end-user may access, program, and/or modify. The end-user may load firmware onto the customer micro-processor, execute a debugger against the customer micro-processor, read and write the customer micro-processor's memory, and interact with the hardware resources made available to the customer micro-processor by the access orchestrator. The customer micro-processor may be accessible to the end-user through one or more standard programming or debug interfaces, such as JTAG, SWD, or a serial bootloader interface. The algorithm processor core, by contrast, may be inaccessible to the end-user through any interface exposed by the customer micro-processor, and the end-user may have no visibility into the algorithm processor core's firmware, memory, or execution state. Thus, the customer micro-processor may be presented to the end-user as the only processor core of the system.

The interface between the algorithm 208 and customer micro-processors 222, and the immediate supervision of the customer micro-processor's access rights to memory, interfaces and algorithms, is provided by a hardware-implemented access orchestrator 220 which enables continual customer micro-processor supervision and communication without placing any unacceptable, or unpredictable, burden upon the algorithm core. Furthermore, the access orchestrator is configured to enable very high-speed integration between custom user code executing on the customer micro-processor and algorithms executing on the algorithm core, so as to permit end-user customization of algorithms operating in real-time.

Although the access orchestrator 220 is generally described herein as being implemented in hardware, in other embodiments the access orchestrator may be partially implemented in hardware and partially implemented in firmware and/or software, or maybe fully implemented in firmware and/or software.

The overall architecture further enables the FPIPD to retain full custom-functionality even when it is unable to communicate with the microprocessor or microcontroller of a larger host system (e.g., when disconnected with the battery in a battery management application, or when disconnected in a security token in a security token application).

As used herein, the term “core” refers to a programmable processing unit capable of independently executing firmware instructions. A core may comprise a microprocessor, microcontroller, digital signal processor, programmable logic device, or any other execution unit capable of independently executing a sequence of instructions. Two or more cores may reside on a single integrated circuit die and may execute firmware concurrently and independently of one another.

As used herein, the term “peripheral device” refers to an integrated circuit that performs one or more dedicated functions in support of a host system or operates autonomously without a host system. A peripheral device may include analog, digital, or mixed-signal circuitry, one or more processor cores, memory, and hardware interfaces. A peripheral device may be connected to a host system via one or more communication interfaces, or may operate independently of any host system. The term “peripheral device” is not limited to devices that require a host system for operation, and includes devices capable of standalone operation. Examples of peripheral devices include, without limitation, battery management integrated circuits, security authentication tokens, industrial controllers, biopotential sensing devices, and embedded sensing platforms.

### Example System Architecture

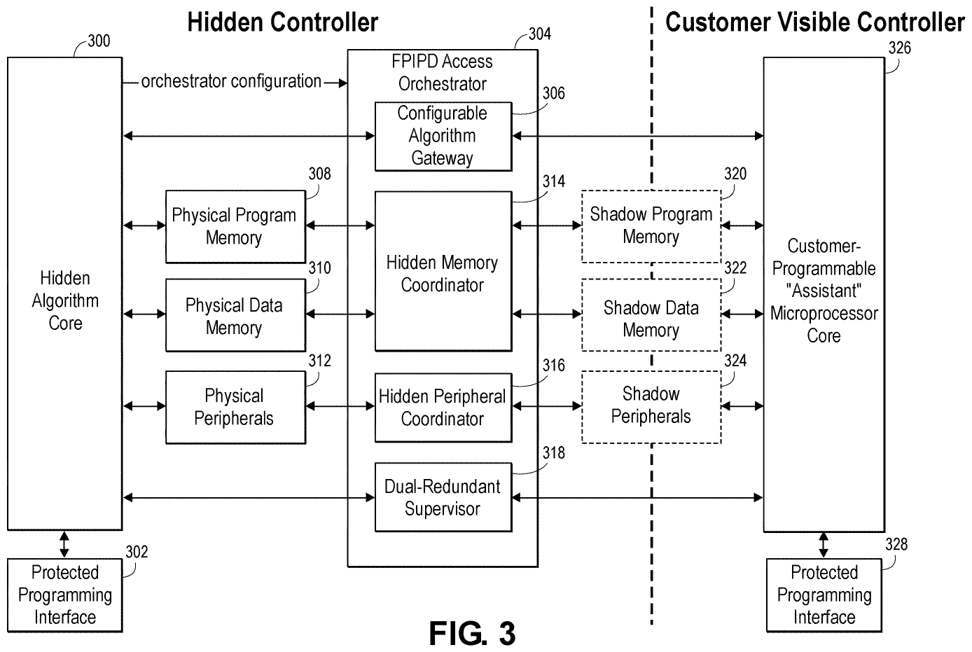

FIG. 3 illustrates a simplified schematic of a system architecture in accordance with embodiments disclosed herein. As shown in FIG. 3, the system consists of three main parts: the customer-programmable “assistant” microprocessor core 326, the hidden “algorithm” FPIPD core 300, and the FPIPD access orchestrator 304. The algorithm core 300 and access orchestrator 304 altogether make up a hidden controller. The hidden controller includes physical program memory 308, physical data memory 310, physical peripherals 312, hidden memory coordinator 314, hidden peripheral coordinator 316, and dual-redundant supervisor 318. The system also includes configurable algorithm gateway 306, shadow program memory 320, shadow data memory 322, and shadow peripherals 324. Both the hidden algorithm core 300 and customer-programmable assistant microprocessor core 326 have protected programming interfaces 302, 328.

The customer micro-processor may include traditional memory, peripheral, and other interfaces. When the customer micro-processor makes requests to these interfaces, the requests may be intercepted by the Access Orchestrator. This interception may be transparent to the customer micro-processor, as the Access Orchestrator may enable the creation of “shadow targets” such that the requests are intercepted without requiring modification to the customer micro-processor's firmware.

The shadow targets (shadow program memory, shadow data memory, shadow peripherals, and others) may not need to physically exist; they may be an abstraction layer provided by the access orchestrator. This may allow the customer micro-processor to utilize the physical memory of the hidden controller without requiring additional physical hardware. However, physically separate memories may still be managed by the access orchestrator where it is deemed advantageous for them to exist.

The access orchestrator may enable the shadow memories via a hidden memory coordinator. The hidden memory coordinator may be configured by the algorithm core to allow read or write access to different segments of memory, while protecting any memory space dedicated to the hidden controller. These protections may be transparent to the customer micro-processor, presenting the customer micro-processor with the appearance of full access to a memory that is a fraction of the available physical memory. The hidden controller may be designed to allow the access orchestrator and algorithm core to access the physical memory substantially simultaneously. This may be accomplished by time-interleaving access requests, or by other approaches such as arbitration or utilizing dual-port memories.

The access orchestrator also enables shadow peripherals. It may make the customer micro-processor think it has dedicated peripherals, when in fact the peripherals are under the direct supervision of the access orchestrator and algorithm core at all times. In the example of a Pulse-Width-Modulation (PWM) peripheral that physically exists only in the hidden controller, the customer micro-processor can make a request to generate a PWM pulse. That request is received by the hidden peripheral coordinator (within the access orchestrator) and the hidden peripheral coordinator makes a request to sequence the physical PWM hardware, only after the algorithm core has approved the request.

The hidden peripheral coordinator enables a wide range of peripheral control schemes. Some controls can be abstracted to a high level, such as specifying the data to be sent out I2C, only after the algorithm core has received a read request at a predefined address. Other controls can be more direct. For example, the customer micro-processor, if enabled and allowed by the algorithm core, can request full access to an I2C peripheral and control it completely as if it were dedicated hardware for the customer micro-processor.

The algorithm core can make itself appear to the customer micro-processor as a hardware engine running a dedicated hardware algorithm, when in fact the algorithm can be almost fully implemented in the algorithm core's firmware. The FPIPD Access Orchestrator contains a configurable algorithm gateway that allows the customer micro-processor to interact with the algorithm core's algorithm in ways far beyond what a traditional I2C interface would allow. The configurable algorithm gateway can be configured by the algorithm core to expose any number of events and commands that the customer micro-processor can subscribe to and execute to tune the algorithm in real time. The flexibility of the configurable algorithm gateway's hardware allows for a wide variety of algorithms within the algorithm core to be implemented with flexible interaction by the customer micro-processor.

Both the algorithm core and customer micro-processor may have dedicated programming interfaces such that the end user may not have any access to the algorithm core when running a debugger on the customer micro-processor. When the end user is programming the customer micro-processor, the programming commands may flow through the hidden memory coordinator such that the algorithm core approves and executes the programming.

Also, within the FPIPD access orchestrator is a dual-redundant supervisor module. This allows for each core to monitor the execution of the other core. If, for example, the customer micro-processor does not appear to be executing correctly, the algorithm core can reboot it, shut it off, and/or go to a fail-safe mode. In other types of systems, the algorithm and customer micro-processors could be programmed with dual-redundant code such that they can monitor each other's execution through this interface.

### Configurable Algorithm Gateway

One function of the Configurable Algorithm Gateway may be to expose deep controls to a hidden software algorithm. Examples of exposable controls may include the following.
a) Augment a weighting factor of the algorithm within acceptable bounds.
b) Choose which steps of the algorithm should run or not run.
c) Don't change the underlying algorithm, but augment the inputs or outputs. For example, apply an offset bias of the input data.
d) Tell parts of the algorithm to run more or less often. For example, request the initialization procedure to rerun.
e) Implement replacement sub-sections of the algorithm code.

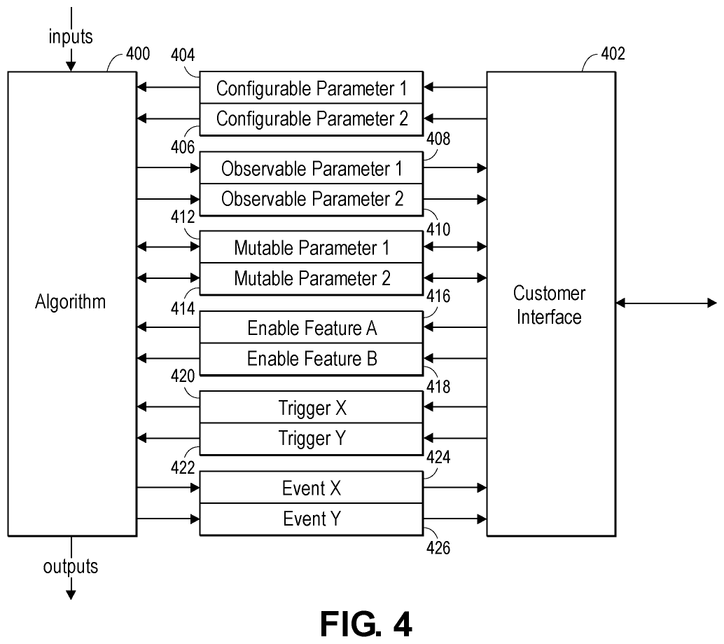

FIG. 4 illustrates a simplified block diagram of an example Configurable Algorithm Gateway in accordance with embodiments of the disclosure. As shown in FIG. 4, the Configurable Algorithm Gateway may enable one or more of the above features using: configurable parameters 404, 406, observable parameters 408, 410, mutable parameters 412, 414, feature enables 416, 418, triggers 420, 422, and events 424, 426. The algorithm 400 interfaces with the customer interface 402 through these various parameter types.
a) Configurable parameters are static parameters that the customer can modify. These parameters are then used within the algorithm. For example, a filter weighting coefficient.
b) Observable parameters are dynamic parameters that are generated by the algorithm. They can be internal states that give the customer better insight into how the algorithm is performing.
c) Mutable parameters are variables that the algorithm periodically updates. The customer can read these parameters and then update them.
d) Feature enables simply turn on and off features or sections of the algorithm.
e) Triggers allow the customer to run certain parts of the algorithm more often or as needed.
f) Events are triggers sent from the algorithm to the customer. The customer can subscribe to the events.

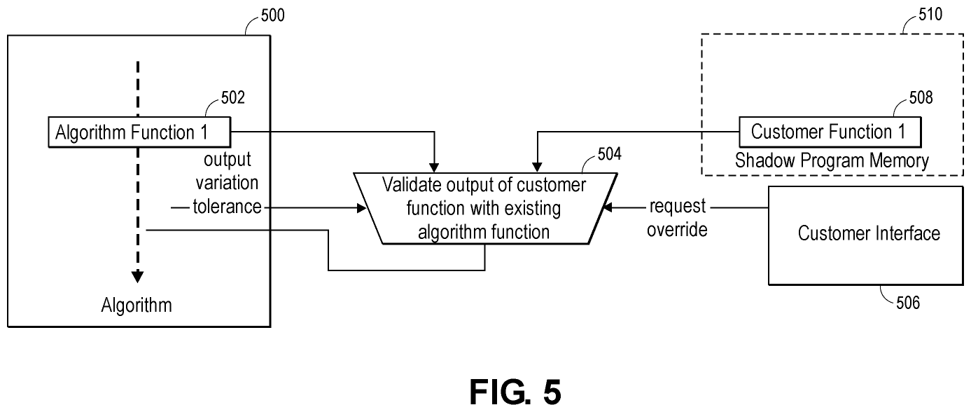

FIG. 5 illustrates a simplified block diagram of another Example Configurable Algorithm Gateway in accordance with embodiment of the disclosure. As shown in FIG. 5, the Configurable Algorithm Gateway consists of the ability for the customer CPU to define segments of its own memory that run in place of the algorithm 500. The algorithm 500 includes algorithm function 1 502, while the customer interface 506 includes customer function 1 508 within shadow program memory 510. This is done by the customer interface sending a request for override of defined parts of the algorithm. The customer sends a pointer to the new function within its shadow memory and the new function is executed in place of the existing algorithm segment. Optionally, a validator 504 can compare the output of the customer's function with the output of the known working algorithm's function and the customer function can be discarded if the outputs are not within an expected tolerance as defined by the algorithm. This method can be used not only for functions, but also parameters.

Any combination of the two above-mentioned Configurable Algorithm Gateways can be combined.

### Hidden Memory Coordinator

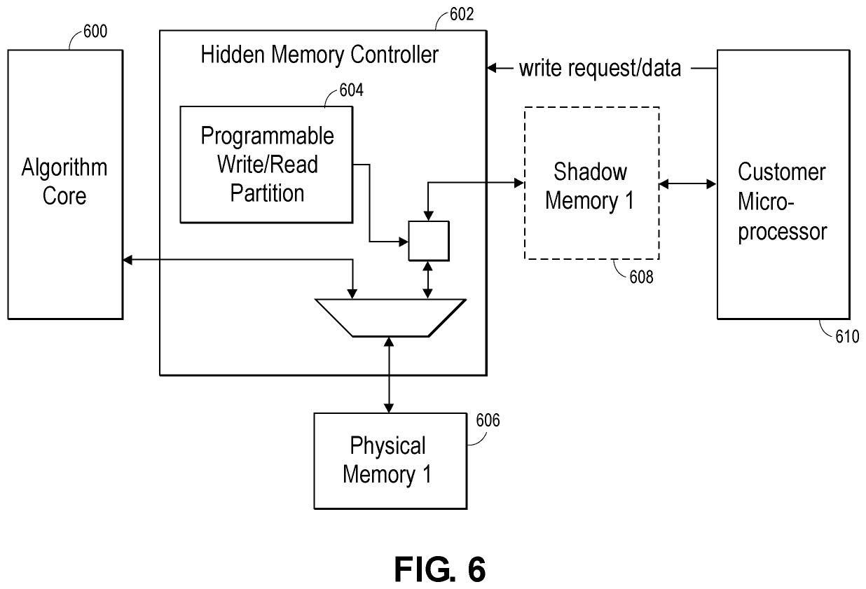

FIG. 6 illustrates a simplified block diagram of a Hidden Memory Coordinator according to embodiments of the disclosure. As shown in FIG. 6, in some embodiments one function of the Hidden Memory Coordinator 602 is to allow the hidden algorithm core 600 and customer micro-processor 610 to share access to the same memory in a way that gives the algorithm core control over the security and visibility of the memory. The hidden memory controller 602 may include a programmable write/read partition 604 that manages access to physical memory 1, 606 and shadow memory 1, 608. One approach may use an arbiter built into the memory. This arbiter may be augmented with programmable partitions, ensuring that each processor has a dedicated space that the other processor cannot access. In this case, only one processor (the algorithm processor) may have control over how this partition is set. The algorithm processor may retain access to the memory while limiting customer access to given segments.

The example in FIG. 6 shows a programmable partition that controls not only what memory segment(s) the customer micro-processor is allowed to access, but also if the segments can be read, written to, or both.

If, for example, the customer shadow memory is read-only, the physical memory can be written through a special request to the Hidden Memory Controller (if available). This allows the Hidden Memory Controller to coordinate with the algorithm core as to when to write to the memory. This may be useful for memories having very slow write speeds that would cause stalling on both cores. A stall request could be made to the customer micro-processor when the algorithm CPICPD wants to write to the memory, but this may not be necessary because there may be no expectation of throughput on the customer micro-processor.

There are several ways to implement an arbiter for this system, such as, but not limited to:
a) Shared clock arbiter: this type of arbiter system expects both processors to use the same clock thus only allowing one processor to access the memory at a time. Several different arbiter schemes can be used in these systems, such as:
b) A fixed priority arbiter whereby one microprocessor always has priority over the other for memory access.
c) A round-robin arbiter whereby once one microprocessor has completed a request, the other microprocessor has the priority when making its next request, and so on, effectively giving both processors equal weight of priority.
d) Dual-port memory: some memories enable the ability to make simultaneous transactions on two separate ports. Using a dual-port memory, each processor could make an independent access without contenting with the other processor. In the case that only one processor is allowed to make write transitions, this becomes even easier to design.
e) Double data rate time interleaving: this type of system clocks the memory twice as fast as the processors. For example, the memory is clocked at 10 MHz and each processor is clocked at 5 MHz. By interleaving the 5 MHz clocks each processor can access the memory at a 5 MHz rate without any contention that would require an arbiter.

### Hidden Peripheral Coordinator

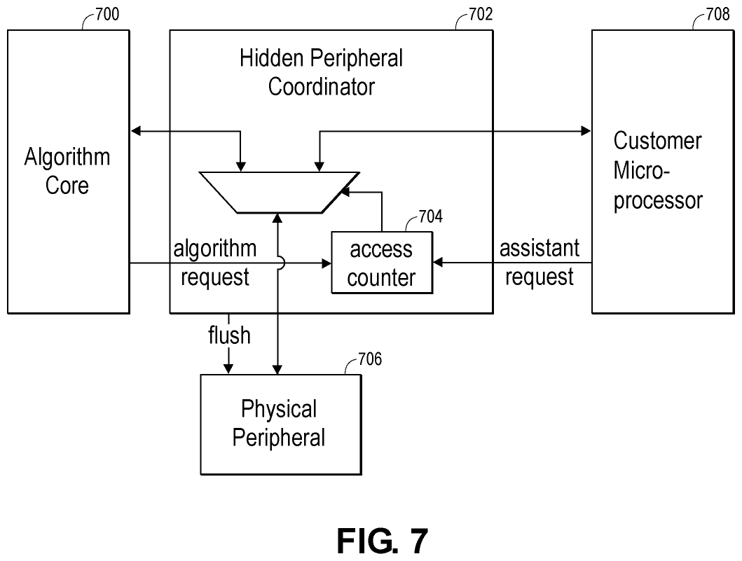

FIG. 7 illustrates a simplified block diagram of a Hidden Peripheral Coordinator 702 in accordance with embodiments of the disclosure. As shown in FIG. 7, the Hidden Peripheral Coordinator 702 may allow the algorithm core 700 and the customer micro-processor 708 to access shared peripherals. The hidden peripheral coordinator 702 includes an access counter 704 and manages access to physical peripheral 706. This sharing of resources saves power, pins, and area in the resulting physical implementation. The implementation of the Hidden Peripheral Coordinator 702 might depend on the type of peripheral that is being shared.

One embodiment allows a physical peripheral to be shared by allowing only one core to access it at a time. When the customer micro-processor requests access, the state of the peripheral might need to be flushed. For example, if the peripheral is an encryption accelerator, any previous data needs to be deleted to ensure the other core doesn't have access to it.

The Hidden Peripheral Coordinator 702 can contain an access counter 704 that can be used to ensure that the peripheral is not overused. For example, the algorithm core 700 can tell the hidden peripheral coordinator 702 that it will need access to the peripheral at least once per second. Knowing that the clock frequency is, for example, 1 MHz (1,000,000 clock cycles per second) and that the peripheral takes 1,000 clock cycles to do a computation, the access counter can be set to 1,000,000−1,000=999,000. If the access counter reaches 0, the customer micro-processor 708 will be locked out until the access counter is reset at the beginning of the next second. Margin can of course also be added to the access counter to account for variability in access frequency and overhead. Furthermore, one or more access counter can be shared between one or more peripherals.

Some peripherals may have usage modes whereby the algorithm core does not need to access them at all. For example, there could be a configuration that has 2 I2C peripherals. In one application, the algorithm core controls both peripherals. In a different application, the algorithm core only uses one I2C and the second is left unused. In this case, the customer micro-processor can request full access to the peripheral for all time and control it directly and there is no need to have an access counter.

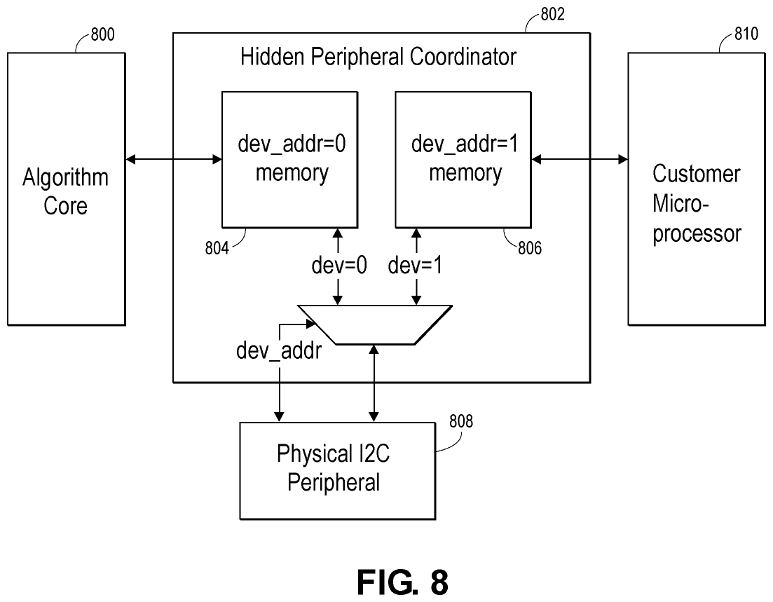

FIG. 8 illustrates a simplified block diagram of another Hidden Peripheral Coordinator 802 in accordance with embodiments of the disclosure. As shown in FIG. 8, this embodiment includes a Hidden Peripheral Coordinator 802 that shares memory. The algorithm core 800 and customer micro-processor 810 both interface with the hidden peripheral coordinator 802, which includes devaddr=0 memory 804 and devaddr=1 memory 806, and manages access to physical I2C peripheral 808. This type of coordinator may be used for serial interfaces. The coordinator can be configured to access shared memory spaces for both cores. Depending on the address requested (or the device address in the case of I2C), the Hidden Peripheral Coordinator 802 will determine which core should service the request and access the dedicated memory space within that core's purview to service the request. In this way, the cores only have to ensure the memory has up to date information in their dedicated memory space to quickly service an I2C read request. Peripheral interrupts can be sent to the cores so that they know an event has happened.

The memory regions of the memory-sharing coordinator can be divided based on device address, register address, any combination therein, or another scheme altogether. Using I2C with a more extreme example, the memory-sharing coordinator could be configured such that only register address 3 of device_id 1 be allocated to the customer micro-processor with all other address/device_id combinations being allocated to the algorithm core.

In some embodiments, the shared memory spaces managed by the Hidden Memory Coordinator and the Hidden Peripheral Coordinator may serve as a communication channel between the algorithm core and the customer micro-processor. Each core may read from and write to designated regions of the shared memory to exchange data, status information, commands, and responses. The algorithm core may define which memory regions are readable and writable by the customer micro-processor, and may update those regions at any time to communicate state changes or instructions to the customer micro-processor. The customer micro-processor may similarly write to its designated memory regions to communicate requests or data to the algorithm core. This shared memory message passing approach may allow the two cores to communicate asynchronously without requiring a dedicated inter-core bus or communication peripheral. Peripheral interrupts may be used to notify each core when new information has been written to the shared memory by the other core.

In some embodiments, the access orchestrator may exchange information between the algorithm core and the customer micro-processor using data packets. Each data packet may include a header identifying the source core, the destination core, and the type of information being exchanged, along with a payload carrying the information itself. Data packets may be used to communicate parameter updates, access requests, event notifications, and responses between the algorithm core and the customer micro-processor. The use of data packets may allow the access orchestrator to queue, prioritize, and validate inter-core communications before forwarding them to the destination core.

### Dual Redundant Supervisor

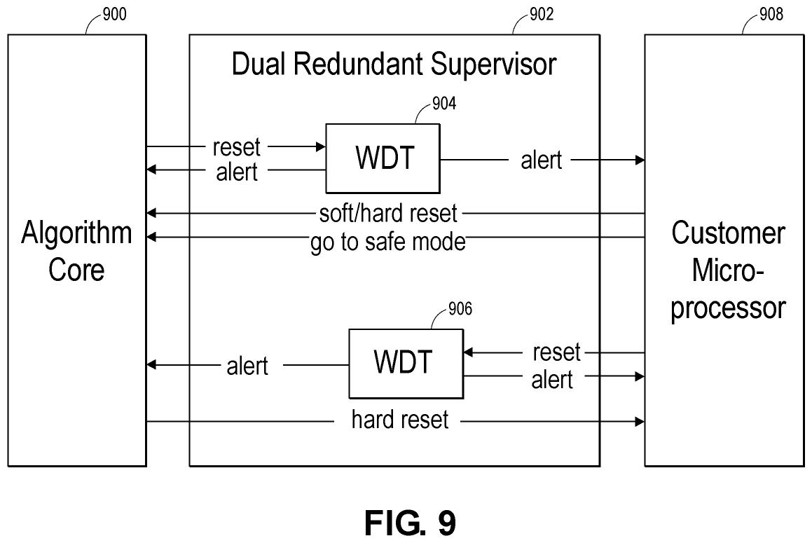

FIG. 9 illustrates a simplified block diagram of a Dual Redundant Supervisor 902 in accordance with embodiments disclosed herein. As shown in FIG. 9, the algorithm core 900 and customer micro-processor 908 are connected through dual redundant supervisor 902, which includes WDT upper 904 and WDT lower 906. Many applications, such as automotive-grade battery management, require very high quality levels. One such requirement is that of ensuring that the calculations made by the algorithm core 900 are correct. The Dual Redundant Supervisor 902 enables the customer micro-processor 908 to monitor the algorithm core 900 with different levels of redundancy and supervision.
Option 1: Full dual redundancy. The customer micro-processor 908 can execute the same code as the algorithm core 900. The Dual Redundant Supervisor 902 allows the algorithm core 900 to interrogate the results of the customer micro-processor 908 via direct memory access of the customer micro-processor's data memory.
Option 2: Curated Supervision. In this mode, the Dual Redundant Supervisor 902 may allow the customer micro-processor 908 to monitor the progress of the algorithm core 900. The events and parameters from the Configurable Algorithm Gateway may be used by the customer micro-processor 908 to determine the validity and competence of the algorithm core 900. If the algorithm core 900 is determined to be experiencing reliability issues, the customer micro-processor 908 may take one or more predefined actions, such as requesting a soft or hard reset of the system, triggering diagnostics or self-tests of the algorithm core, transitioning to a known safe mode, attempting to recover the state of the algorithm core, or shutting down the system.

The Dual Redundant Supervisor 902 may also allow the algorithm core 900 to reset the customer micro-processor 908 if the customer micro-processor 908 is determined to be in a faulty state. This determination may be based on one or more conditions, such as expiration of the shared watchdog, or the customer micro-processor failing to respond to requests made via the Configurable Algorithm Gateway, Hidden Peripheral Coordinator, or Hidden Memory Coordinator.

The mutual visibility of each core's watchdog timer (WDT) through the Dual Redundant Supervisor 902 makes it easy for each core to keep tabs on the operation of the system and take action if needed.

### Example Applications

While the embodiments described above have primarily discussed battery management applications, the systems and algorithms described herein can be used for many other applications, such as, but not limited to:
a) Biomedical devices, such as EKG, EEG, blood glucose, or other externally monitored biopotentials where the sensor algorithms could benefit from such isolation.
b) Field-updateable medical implants whereby the updateable features should be isolated from the mission-critical firmware that cannot afford to be broken.
c) A platform that can check/validate an updated algorithm before committing it to the production system.
d) Two processors that are dual-redundant in a more efficient system than having two physical chips.
e) Allowing for field-training of algorithms in a non-critical processor that can augment the “proven” algorithm in the critical processor system. For example, monitoring battery aging or using an observer to track system outputs over time and detect anomalies.
f) Life-support systems that monitor a patient and control systems, some of which are not mission critical like displays and logging.
g) Audio/video algorithms, such as detection and tracking, which require the algorithms to remain isolated as they are trade secret.
h) Localization and navigation algorithms that use IMU/accelerometer data to determine position, activity, or relative location, such as livestock tracking, office occupancy detection, and asset management.
i) Any system where multiple functional components could be integrated to save space and cost, such as a wearable device whereby the act of integration has a risk of breaking one of the sub-component functions.
j) Any application that requires proprietary trade-secret algorithms that the IC manufacturer doesn't want to divulge to a customer, while still allowing the customer to add their own code to that part. Such as advanced date/time based calculations, DSP algorithms, AI algorithms, and edge processing.
k) Foster the sales of trade-secret algorithms.
l) Enabling the white-labeling of algorithm/security driven products, such as home appliances, home automation, security monitoring, and healthcare.
m) Enabling safe UAV and defense applications whereby mission critical software/hardware cannot afford to be interrupted/compromised by customized software modules that are not mission critical.
n) Automotive and aerospace applications whereby there is a critical safety boundary between mission critical systems and other non-critical systems.
o) A system that contains a security enclave whereby all security-related functions can be isolated from potentially compromised user code.

In some embodiments, the peripheral device may be configured as a security authentication token. In such embodiments, the algorithm core may store and process cryptographic key material and may execute authentication algorithms, such as public-key cryptography, symmetric encryption, hash functions, or one-time password generation. The customer micro-processor may handle user-facing functions, such as communication protocol handling, display output, user interface processing, and event logging. The access orchestrator may ensure that the customer micro-processor cannot access the cryptographic key material stored in the algorithm core's protected memory. The configurable algorithm gateway may allow the customer micro-processor to trigger authentication operations and receive authentication results without exposing the underlying cryptographic keys or algorithms. In this way, the architecture may provide a hardware-enforced boundary between mission-critical cryptographic functions and user-programmable peripheral functions on a single integrated circuit.

It will be apparent to those skilled in the art that substantial variations may be made in accordance with specific implementations. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The terms “machine-readable medium” and “computer-readable medium” as used herein refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media, punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable storage medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, compact disc read-only memory (CD-ROM) or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer-readable storage medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

What is claimed is:

1. A management system for an electronic device, the management system comprising:
an algorithm processor core configured to execute protected firmware that is inaccessible to an end-user, wherein the firmware controls at least one parameter of the electronic device and wherein the algorithm processor core has unrestricted access to one or more hardware resources of the electronic device;
an assistant processor core accessible to the end-user and configured to execute end-user firmware independently programmable by the end-user; and
an access orchestrator configured to intercept requests from the assistant processor core to access the one or more hardware resources of the electronic device and to selectively permit or deny the requests based on permissions established by the algorithm processor core, wherein the algorithm processor core, the assistant processor core and the access orchestrator are disposed on a unitary integrated circuit.

2. The management system of claim 1, wherein the protected firmware is not accessible via a programming interface of the assistant processor core.

3. The management system of claim 1, wherein the at least one parameter of the electronic device includes a state of charge.

4. The management system of claim 1, wherein the one or more hardware resources of the electronic device include a memory.

5. The management system of claim 1, wherein the electronic device is a rechargeable battery and wherein the management system is a battery management system for the rechargeable battery.

6. The management system of claim 1, wherein the one or more hardware resources comprise a shadow memory accessible by the assistant processor core, and wherein the shadow memory corresponds to a portion of a physical memory shared with the algorithm processor core.

7. The management system of claim 6, wherein the assistant processor core's access to the shadow memory is controlled by the algorithm processor core.

8. The management system of claim 1, wherein the electronic device is a security authentication token.

9. The management system of claim 1, wherein the electronic device further comprises at least one hardware-implemented peripheral interfaces including a pulse-width modulated unit, an I2C serial bus, a real-time clock, a timer, or a watchdog timer.

10. The management system of claim 1, wherein the access orchestrator exchanges information between the algorithm processor core and the assistant processor core using message passing in a shared memory.

11. The management system of claim 1, wherein the access orchestrator exchanges information between the algorithm processor core and the assistant processor core using data packets.

12. A method of operating a management system for an electronic device, the method comprising:
executing, on an algorithm processor core of a unitary integrated circuit, protected firmware that is inaccessible to an end-user;
executing, on an assistant processor core of the unitary integrated circuit, end-user firmware that is independently programmable by the end-user;
intercepting, by an access orchestrator of the unitary integrated circuit, requests from the assistant processor core to access one or more hardware resources of the electronic device; and
selectively permitting or denying the intercepted requests based on permissions established by the algorithm processor core.

13. The method of claim 12, further comprising presenting the assistant processor core to the end-user as a sole processor of the management system, such that the algorithm processor core is inaccessible to the end-user.

14. The method of claim 12, further comprising configuring, by the algorithm processor core, a programmable partition of a shared physical memory to define a shadow memory region accessible by the assistant processor core.

15. The method of claim 14, further comprising controlling the assistant processor core's access to the shadow memory with the algorithm processor core.

16. The method of claim 12, wherein the access orchestrator exchanges information between the algorithm processor core and the assistant processor core using message passing in a shared memory.

17. A unitary integrated circuit comprising:
an algorithm processor core configured to execute protected firmware that is inaccessible to an end-user of the integrated circuit, wherein the firmware controls at least one parameter of an electronic device and wherein the algorithm processor core has unrestricted access to one or more hardware resources of the electronic device;
an assistant processor core configured to execute end-user firmware independently programmable by the end-user; and
an access orchestrator coupled between the algorithm processor core and the assistant processor core and configured to intercept requests from the assistant processor core to access the one or more hardware resources of the electronic device and to selectively permit or deny the requests based on permissions established by the algorithm processor core.

18. The unitary integrated circuit of claim 17, wherein the assistant processor core is presented to the end-user as a sole processor of the unitary integrated circuit.

19. The unitary integrated circuit of claim 17, wherein the access orchestrator is further configured to enforce a programmable partition of a shared physical memory, the programmable partition defining a shadow memory region accessible by the assistant processor core and controlled by the algorithm processor core.

20. The unitary integrated circuit of claim 17, wherein the access orchestrator exchanges information between the algorithm processor core and the assistant processor core using message passing in a shared memory.
